(19) United States
(12) Patent Application Publication
(10) Pub. No.: US 2010/0118323 A1
(43) Pub. Date: May 13, 2010

(54) IMAGE FORMING APPARATUS

(75) Inventor: Takashi Horikawa, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Tokyo (JP)

(21) Appl. No.: 12/614,849

(22) Filed: Nov. 9, 2009

(30) Foreign Application Priority Data
Nov. 10, 2008 (JP) 2008-287693

(51) Int. Cl. G06K 15/02

(52) U.S. Cl. 358/1.11

(57) ABSTRACT

An image forming apparatus includes an input receiving unit that receives a character to be printed and a font family of the character as inputs, a first outline specifying data generating unit that generates first outline specifying data corresponding to a combination of the character and the font family which are input to the input receiving unit, an image formation data generating unit that generates data for image formation, which corresponds to the combination of the character and the font family, based on the generated first outline specifying data, a cache unit that temporarily stores the first outline specifying data, a priority calculating unit that calculates priorities related to the first outline specifying data based on the number of curve commands included in the first outline specifying data.

### BACKGROUND

1. Technical Field

The present invention relates to an image forming apparatus, and, more particularly, to caching of a font in the case of printing a character image.

2. Related Art

For example, JP-A-6-195057 discloses a technology for caching raster data corresponding to characters of a predetermined number or less and outputting cached characters without generating raster data again in an output apparatus such as a display apparatus or a printing apparatus. According to JP-A-6-195057, a cache bit rate is improved by using cost information as cache priority, so that an output process is performed at a higher speed. The cost information includes the appearance frequency of characters.

In general, an image forming apparatus such as a printer employs an outline font as a character font for printing. In a case in which the outline font is employed, when characters are printed, for example, after data (hereinafter, referred to as “outline specifying data”) is generated to specify the outline of the characters, raster data is generated from the generated outline specifying data. Then, the characters are printed based on the generated raster data.

The above-described technology can be applied to an image forming apparatus such as the printer and caching of the outline specifying data or the raster data can be controlled based on the cost information.

However, in a case in which a graphic image is printed by the image forming apparatus, since there are not many characters included in an image to be printed, it is not effective to determine whether to perform a cache operation based on the appearance frequency of characters.

### SUMMARY

An advantage of some aspects of the invention is to effectively control the caching of a font in an image forming apparatus.

According to one aspect of the invention, there is provided an image forming apparatus including an input receiving unit that receives a character to be printed and a font family of the character as inputs, a first outline specifying data generating unit that generates first outline specifying data corresponding to a combination of the character and the font family which are input to the input receiving unit, an image formation data generating unit that generates data for image formation, which corresponds to the combination of the character and the font family, based on the generated first outline specifying data, a cache unit that temporarily stores the first outline specifying data, a priority calculating unit that calculates priorities related to the first outline specifying data based on the number of curve commands included in the first outline specifying data, and a cache controller that determines whether to cache the generated first outline specifying data based on the calculated priorities, and stores the generated first outline specifying data in the cache unit when a positive determination result is obtained.

A preferred embodiment of the invention further includes a second outline specifying data generating unit, which generates second outline specifying data corresponding to the combination of the character and the font family which are input to the input receiving unit, the first outline specifying data generating unit may generate the first outline specifying data, which corresponds to the combination of the character and the font family, based on the generated second outline specifying data, the priority calculating unit may calculate the priorities based on the number of the curve commands included in the first outline specifying data, or the number of curve commands included in the second outline specifying data instead of the first outline specifying data, the first outline specifying data generating unit and the image formation data generating unit may have an input/output interface based on OpenVG specifications, and the first outline specifying data may have a data format based on the OpenVG specifications.

According to the preferred embodiment of the invention, the priority calculating unit may calculate the priorities based on the number of straight line commands in addition to the number of the curve commands.

According to the preferred embodiment of the invention, the priority calculating unit may calculate weighted priorities according to the complexity of a curve represented by the curve commands when two or more types of curve commands exist.

According to the preferred embodiment of the invention, the priority calculating unit may replace the curve commands with the straight line commands, which represent a plurality of straight lines expressing a curve represented by the curve commands, and calculate the priorities based on the number of straight line commands instead of the curve commands.

According to the preferred embodiment of the invention, an upper limit number of the first outline specifying data, which is cacheable, may be set in advance, the first outline specifying data and the priorities related to the first outline specifying data may be stored in the cache unit in such a manner that the first outline specifying data is linked to the corresponding priorities, and the cache controller, in a case in which the number of the cached first outline specifying data reaches a cache-upper limit number, may determine to cache the generated first outline specifying data when the priorities calculated by the priority calculating unit are equal to or greater than the lowest value of priorities related to the cached first outline specifying data.

According to the preferred embodiment of the invention, the cache controller may store a threshold value of the priorities, which serves as a cache determination reference, and may determine to cache the generated first outline specifying data when the priorities calculated by the priority calculating unit are equal to or greater than the threshold value.

### BRIEF DESCRIPTION OF THE DRAWINGS

The invention will be described with reference to the accompanying drawings, wherein like numbers reference like elements.

FIG. 1 is a block diagram showing an example of a configuration of a printer according to one embodiment of the invention.

FIG. 2 is a block diagram showing one example of a functional configuration of a character imaging processing unit.

FIG. 3A is a view showing an example of an XML document used for describing outline specifying data.

FIG. 3B is a view showing an imaging example of a character array “SVG” in a case in which a font is defined as shown in FIG. 3A.

FIG. 4 is a table showing one example of point values set in each path command.

FIG. 5 is a flow chart showing a character imaging process according to the embodiment.

### DESCRIPTION OF EXEMPLARY EMBODIMENTS

Hereinafter, an embodiment of the invention will be described in detail with reference to the accompanying drawings.

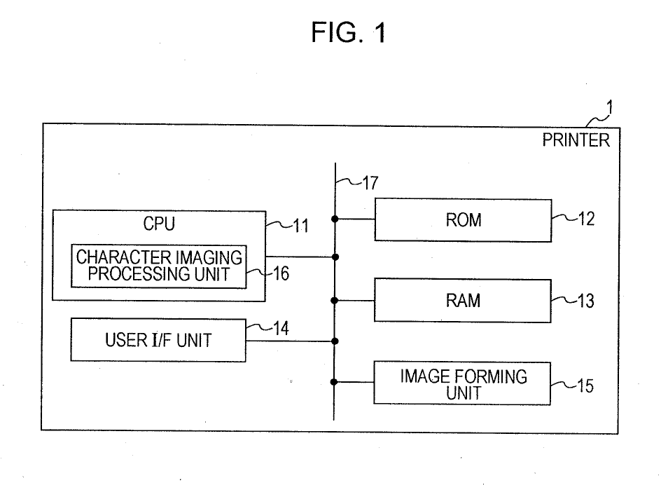

FIG. 1 is a block diagram showing an example of a configuration of a printer 1 according to the embodiment of the invention.

The printer 1, for example, includes a CPU (Central Processing Unit) 11, a ROM (Read Only Memory) 12, a RAM (Random Access Memory) 13, a user I/F (interface) unit 14, and an image forming unit 15. The CPU 11, the ROM 12, the RAM 13, the user I/F unit 14 and the image forming unit 15 are connected to each other through a bus 17.

The ROM 12, for example, stores various types of programs such as an image forming control program for controlling the image forming unit 15 and a character imaging processing program for executing the functions of a character imaging processing unit 16. The RAM 13 serves as an area for storing programs and data or a working area for storing data used for the processing of the CPU 11. The user I/F unit 14 receives a manipulation signal of a user and displays various screens to be provided to the user. The user I/F unit 14, for example, may include a touch panel. The image forming unit 15, for example, forms an image on an image forming medium such as a paper, an OHP sheet, a thick paper and an envelope. The image forming unit 15, for example, forms character images (or character arrays), which are represented by raster data input from the character imaging processing unit 16, on the image forming medium.

The CPU 11 reads the program stored in the ROM 12 to the RAM 13 such that the program is executed, thereby controlling operations of the elements 12 to 15. For example, the CPU 11 executes the image forming control program to control the operation of the image forming unit 15. Further, the CPU 11 executes the character imaging processing program to perform the function of the character imaging processing unit 16. The character imaging processing unit 16 performs imaging of input characters (or a character array) to perform a process (hereinafter, referred to as a character imaging process) of generating raster data corresponding to the characters (or the character array). The character imaging process will be described in detail later.

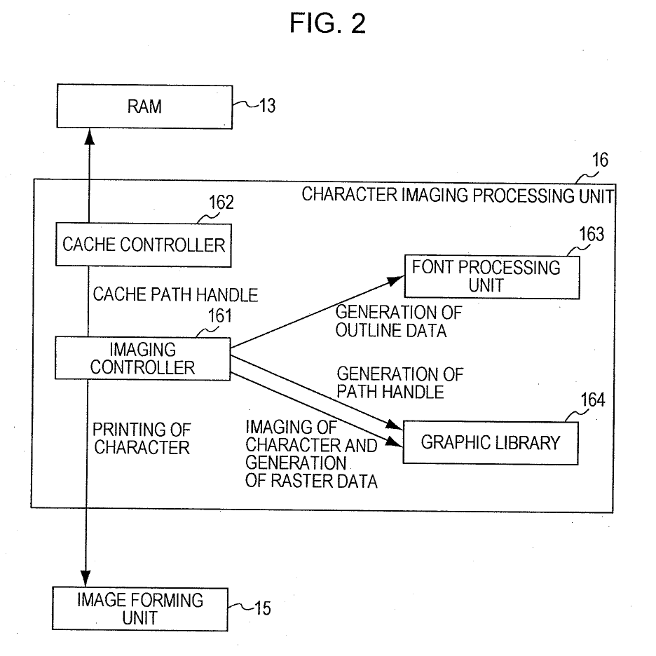

FIG. 2 is a block diagram showing one example of the functional configuration of the character imaging processing unit 16.

The character imaging processing unit 16, for example, includes an imaging controller 161, a cache controller 162, a font processing unit 163 and a graphic library 164.

The imaging controller 161 controls all elements of the character imaging processing unit 16 to perform the character imaging process. The font processing unit 163 manages information on character fonts (e.g., Hiragana, Katakana, alphanumeric characters, marks, Chinese characters and the like) serving as objects. Further, the font processing unit 163 generates data (outline specifying data) for specifying a character outline, which corresponds to a combination of input characters and a font name (font family). According to the embodiment, the outline specifying data generated from the font processing unit 163 will be referred to as outline data. The outline of the character is formed by combining one or more segments of a line (straight line or curve). According to the embodiment, the respective segments that constitute the outline of the characters will be referred to as a path.

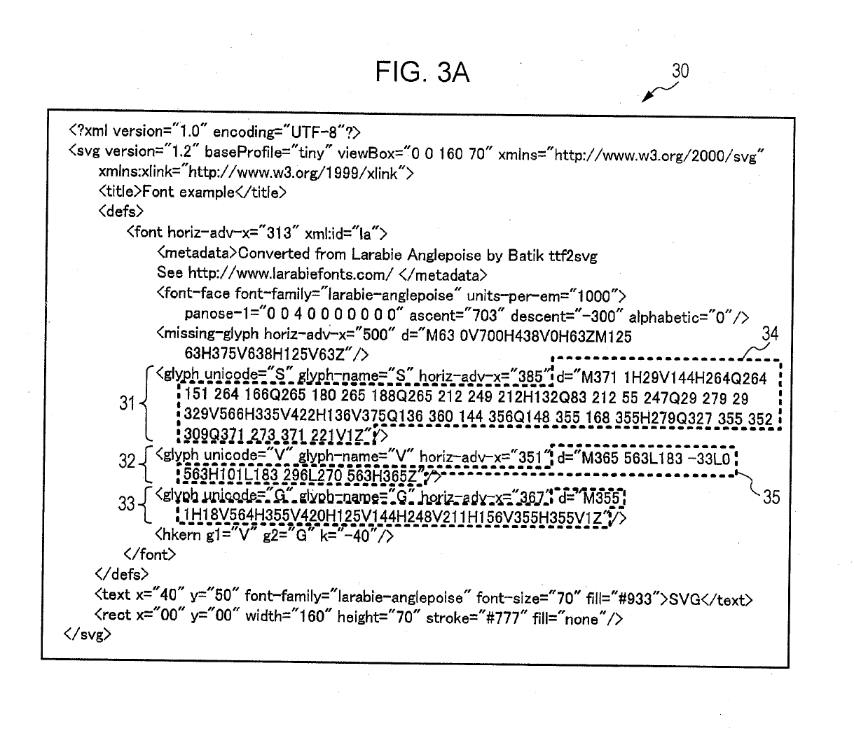

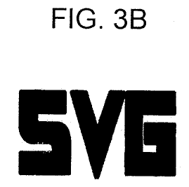

Hereinafter, the outline specifying data will be described with reference to FIG. 3 (FIGS. 3A and 3B). Herein, a case in which the outline specifying data is defined by a description language of a vector image called SVG (Scalable Vector Graphics) will be described as an example.

FIG. 3A is a view showing an example of an XML (Extensible Markup Language) document 30 used for describing the outline specifying data.

In the XML document 30 shown in FIG. 3A, fonts of characters “S”, “V” and “G” are defined by the SVG. Reference numeral 31 denotes a section in which the font of the character “S” is defined. Reference numeral 32 denotes a section in which the font of the character “V” is defined. Reference numeral 33 denotes a section in which the font of the character “G” is defined.

The font definition sections 31, 32 and 33 respectively include outline specifying data 34, 35 and 36. Reference numeral 34 denotes outline specifying data related to the character “S”. Reference numeral 35 denotes outline specifying data related to the character “V”. Reference numeral 36 denotes outline specifying data related to the character “G”. As shown in FIG. 3A, the outline specifying data 34, 35 and 36 each include one or more combinations of commands (expressed by alphabetic characters, hereinafter, referred to as path commands), which are used for imaging paths, and coordinate positions (expressed by numerals) to which the commands are applied. For example, the outline specifying data 35 related to the character “V” includes four “L” path commands and two “H” path commands. The “L” commands are used for imaging straight lines and the “H” path commands are used for imaging horizontal lines, which will be described later. Thus, the outline specifying data 35 of the character “V” represents that imaging of the character “V” is performed by imaging four straight lines and two horizontal lines. In other words, the outline specifying data 35 of the character “V” represents that the outline of the character “V” is formed using the four straight lines and the two horizontal lines. In a case in which the fonts are defined as shown in FIG. 3A, the character array “SVG”, for example, is imaged as shown in FIG. 3B.

Further, the outline specifying data (outline data) generated from the font processing unit 163 has a data format different from a data format of outline specifying data defined by the SVG However, basically, the outline specifying data generated from the font processing unit 163 includes information identical to information included in the outline specifying data defined by the SVG. That is, the outline specifying data (outline data) generated from the font processing unit 163 also includes one or more combinations of path commands and coordinate positions to which the path commands are applied.

Up to now, the outline specifying data has been described. Hereinafter, the character imaging processing unit 16 will be described with reference to FIG. 2.

The graphic library 164 provides a multi-purpose API (Application Programming Interface, hereinafter, referred to as an imaging API) which is used for imaging characters, diagrams and the like. The imaging API, for example, employs OpenVG, GDI+ and the like. The imaging API, for example, includes an API (hereinafter, referred to as a path handle generation API) which is used for generating a path handle, an API (hereinafter, referred to as a character imaging API) used for performing imaging of characters in correspondence with the path handle, and the like. The path handle denotes outline specifying data with a data structure defined in the graphic library 164. The path handle is generated through a combination of characters and font families. Further, the outline data and the path handle as described above are outline specifying data, that is, data for specifying the outline of characters (respective paths constituting the outline of characters). However, the data structures of the outline data and the path handle are different from each other. The character imaging processing unit 16 performs imaging of characters by using the imaging API which is a multi-purpose API, so that the outline data is converted into the path handle. The path handle includes a plurality of path commands similarly to the outline data.

Hereinafter, an outline of the character imaging process performed by the character imaging processing unit 16 will be described.

First, the imaging controller 161 receives information (e.g., character codes) representing a character to be printed and a font family of the character as inputs. Hereinafter, the character received in the imaging controller 161 will be referred to as an “input character” and the font family received in the imaging controller 161 will be referred to as an “input font family”.

Then, the imaging controller 161 requires the font processing unit 163 to generate outline data corresponding to a combination of the input character and the input font family. At this time, the imaging controller 161 notifies the font processing unit 163 of the information (character codes), which represents the input character, and the input font family. After receiving the generation request of the outline data, the font processing unit 163 generates the outline data corresponding to the combination of the character and the font family which have been notified thereto, and then outputs the generated outline data to the imaging controller 161.

After the outline data is received from the font processing unit 163, the imaging controller 161 calls a path handle API provided from the graphic library 164 so that path handles are generated from the graphic library 164 in correspondence with the combination of the input character and the input font family. In detail, the graphic library 164 designates the outline data, which corresponds to the combination of the input character and the input font family, and calls the path handle API. If the path handle API is called, the graphic library 164 generates the path handles, which correspond to the combination of the input character and the input font family, based on the designated outline data. Then, the graphic library 164 outputs the generated path handles to the imaging controller 161.

After the path handles are received from the graphic library 164, the imaging controller 161 calls a character imaging API provided from the graphic library 164 to image the input character by using the font represented by the input font family, so that raster data is generated from the graphic library 164 in correspondence with the combination of the input character and the input font family. In detail, the imaging controller 161 designates the path handles, which correspond to the combination of the input character and the input font family, and calls the character imaging API. If the character imaging API is called, the graphic library 164 images the input character by using the font, which is represented by the input font family, based on the designated path handles, thereby generating the raster data corresponding to the combination of the input character and the input font family. Then, the graphic library 164 outputs the generated raster data to the imaging controller 161.

Thereafter, the imaging controller 161 outputs the raster data, which is received from the graphic library 164, to the image forming unit 15. After the raster data is received from the imaging controller 161, the image forming unit 15 forms an image of characters, which is represented by the received raster data, on an image forming medium.

Up to now, the outline of the character imaging process has been described. According to the embodiment, the character imaging processing unit 16 caches the path handles generated from the graphic library 164, that is, stores the path handles in the RAM 13. Thus, in relation to the combination of the character and the font family, which correspond to the cached path handles, imaging for a corresponding character can be performed without allowing the font processing unit 163 to generate the outline data and allowing the graphic library 164 to generate the path handles again. Further, an upper limit number (hereinafter, referred to as a cache-upper limit number) of cacheable path handles is set in advance by taking the capacity of the RAM 13 and the like into consideration. Accordingly, in a case in which the number of the cached path handles reaches the cache-upper limit number, newly generated path handles are cached after one of the cached path handles is deleted, that is, one of the cached path handles is replaced with the newly generated path handles.

The cache controller 162 controls caching of the path handles generated from the graphic library 164. In detail, in a case in which the number of the cached path handles reaches the cache-upper limit number, whenever path handles are newly generated, the cache controller 162 determines to cache the newly generated path handles. The determination, for example, is performed based on priority calculated for each path handle, that is, each combination of characters and font families. Hereinafter, the priority calculated for each path handle (each combination of characters and font families) will be referred to as a path handle priority.

The path handle priority, for example, is calculated based on the outline data corresponding to the combinations of characters with the priority and font families, or based on a path handle with the priority. In detail, the path handle priority is calculated through an equation below based on the type of path commands (point values set in advance for each path command), which are included in the outline data or the path handle, and the number of the path commands. Further, N is a natural number and denotes the total number of the path commands included in the outline data or the path handle. The point values will be described in detail later. In the following description, the path handle priority is calculated based on the outline data.

The path handle priority=(number of first path commands)×(point value of first path commands)+(number of second path commands)×(point value of second path commands)+(number of third path commands)×(point value of third path commands) . . . (number of N^{th} path commands)×(point value of N^{th} path commands).

In a case in which the number of the cached path handles has reached the cache-upper limit number, when path handles have been newly generated, the cache controller 162 calculates path handle priorities of the newly generated path handles by using the above equation. Then, the cache controller 162 compares the path handle priorities of the newly generated path handles with the lowest value (hereinafter, referred to as the lowest priority) of the path handle priorities of the cached path handles. Further, the path handle priorities of the cached path handles are stored in the RAM 13 in such a manner that the path handle priorities of the cached path handles are linked to the corresponding path handles with the priorities. Thus, the cache controller 162 can select the lowest priority from the path handle priorities stored in the RAM 13. In a case in which the path handle priorities of the newly generated path handles are equal to or greater than the lowest priority, the cache controller 162 deletes the path handle with the lowest priority from the RAM 13, and caches the newly generated path handles. At this time, the cache controller 162 stores the path handle priorities of the newly generated path handles in the RAM 13 in such a manner that the path handle priorities of the newly generated path handles are linked to the corresponding newly generated path handles. Thereafter, when the cache controller 162 determines whether to cache the newly generated path handles, the cache controller 162 refers to the path handle priorities stored in the RAM 13.

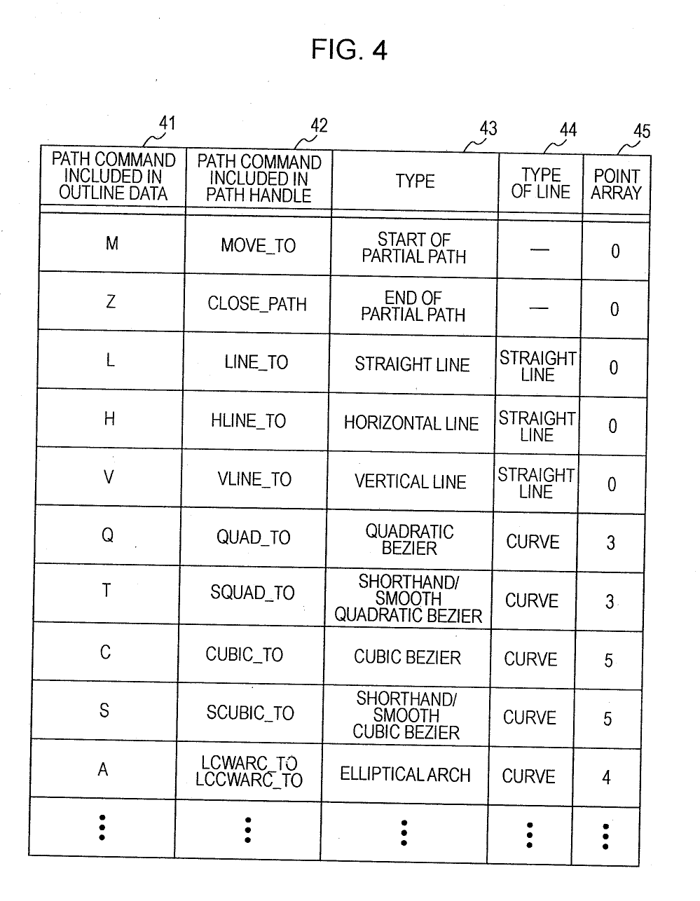

FIG. 4 is a table showing one example of the point values set in advance in each path command.

FIG. 4 shows an example of a plurality of path commands and an example of the point values thereof. Referring to FIG. 4, the path command 41 included in the outline data denotes a path command of outline data in a case in which the outline data has been defined by the SVG Further, the path command 42 included in the path handle denotes a path command of a path handle in a case in which OpenVG is employed as the imaging API.

For example, the “L” path command included in the outline data is identical to the “LINE_TO” path command included in the path handle, and denotes a path command (hereinafter, referred to as a “straight line command”) used for imaging a straight line. Further, the “Q” path command included in the outline data is identical to the “QUAD_TO” path command included in the path handle, and denotes a path command (hereinafter, referred to as a “quadratic Bezier command”) used for imaging a quadratic Bezier curve. Similarly to this, the “C” path command included in the outline data is identical to the “CUBIC_TO” path command included in the path handle, and denotes a path command (hereinafter, referred to as a “cubic Bezier command”) used for imaging a cubic Bezier curve. The quadratic Bezier command and the cubic Bezier command belong to a command (hereinafter, referred to as a “curve command”) used for imaging a curve. Further, various commands exist in addition to the commands.

Normally, relatively large processing quantities are required to generate outline data when there are curved paths constituting an outline, as compared with a case in which the paths constituting the outline are straight lines. That is, a significant amount of time is required to generate the outline data when there are curved paths constituting the outline, as compared with the case in which the paths constituting the outline are straight lines. For example, a character having an outline formed by X curves requires a significant amount of time when outline data is generated, as compared with a character having an outline formed by X straight lines. In this regard, for example, the point value of the curve command is set to be greater than the point value of the straight line command.

Further, in the case when curves with more complicated paths constitute the outline, large processing quantities are required to generate the outline data, and a significant amount of time is required to generate the outline data. For example, a cubic Bezier curve has many control points as compared with a quadratic Bezier curve, and is complicated as compared with the quadratic Bezier curve. In this regard, for example, a character having an outline formed by X cubic Bezier curves requires a significant amount of time when outline data is generated, as compared with a character having an outline formed by X quadratic Bezier curves. Thus, for example, as a curve is complicated, a point value of a path command used for imaging the curve is set to be large.

In addition, in a case in which the processing quantity (processing quantity required to generate data representing a straight line command) related to a straight line part of the processing quantity required to generate the outline data is extremely small as compared with the processing quantity (processing quantity required to generate data representing a curve command) related to a curve part, the processing quantity related to the straight line part can be ignored. In such a case, for example, the point value of the straight line command can be set to “0”.

Referring to the example of FIG. 4, the point value of the straight line command is set to “0” so that a straight line is not considered. Further, the point value of the cubic Bezier command is set to “5” which is greater than the point value “3” of the quadratic Bezier command.

As described above, the point value of the curve command is set to be greater than the point value of the straight line command, and the point value of the curve command related to a more complicated curve is set to be large. In this case, as a combination of a character and a font family causes large processing quantity when outline data is generated, the path handle priority corresponding to the combination is increased. Thus, as the combination of the character and the font family causes the large processing quantity when the outline data is generated, the cache controller 162 can primarily cache path handles corresponding to the combination. In the combination of the character and the font family, in which a significant processing time is required to generate the outline data, the path handles are primarily cached, and imaging of the corresponding character can be performed without generating outline data and path handles again.

Further, without taking the type of the path commands into consideration, large processing quantities are required to generate outline data, so that the path handle priority may be increased as the number of the path commands is increased. In such a case, for example, all point values of the path commands can be set to “1”. Further, after the straight line commands are ignored, the type of the path commands may not be considered. In such a case, for example, the point values of the straight line commands can be set to “0” and the point values of the curve commands can be set to “1”.

In addition, a curve can be expressed by a plurality of straight lines in such a manner that the straight lines approximate the curve. Thus, after all curve commands included in the outline data are replaced with a plurality of straight line commands (i.e., commands used for imaging the straight lines expressing the curve represented by the curve commands), the path handle priority can be calculated based on only the straight line commands. In such a case, the straight line commands may have point values other than “0”.

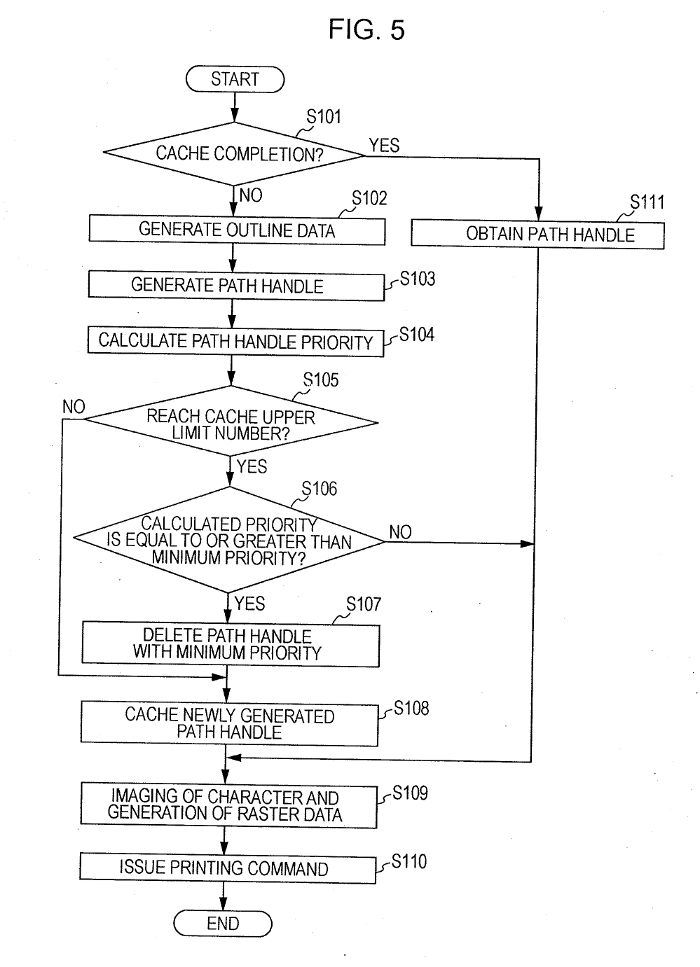

FIG. 5 is a flow chart showing the character imaging process according to the embodiment.

If information (e.g., character codes) representing a character to be printed and a font family of the character are received as inputs, the imaging controller 161 starts the character imaging process.

First, the imaging controller 161 determines whether path handles, which correspond to the combination of the received character (input character) and the received font family (input font family), have been cached (S101).

When the path handles, which correspond to the combination of the input character and the input font family, have been cached (S 101: YES), the imaging controller 161 obtains the cached path handles (reads the cached path handles from the RAM 13) (S111). Then, the imaging controller 161 performs the process of S109.

In contrast, when the path handles, which correspond to the combination of the input character and the input font family, have not been cached (S101: NO), the imaging controller 161 requests the font processing unit 163 that the font processing unit 163 generate outline data corresponding to the combination of the input character and the input font family (S102). After the request is received from the imaging controller 161, the font processing unit 163 generates the outline data corresponding to the combination of the input character and the input font family, and then outputs the generated outline data to the imaging controller 161.

Then, the imaging controller 161 designates the outline data generated in 5102 to call the path handle generation API, and controls the graphic library 164 to generate path handles corresponding to the combination of the input character and the input font family (S103).

Thereafter, the cache controller 162 calculates the path handle priorities (path handle priorities related to the combination of the input character and the input font family) of the path handles, which are generated in S103, based on the outline data generated in S102 (S104).

Next, the cache controller 162 determines whether the number of the cached path handles has reached the upper limit number (cache-upper limit number) of the cacheable path handles (S105).

When the number of the cached path handles has not reached the cache-upper limit number (S105: NO), the process of S108 is performed.

In contrast, when the number of the cached path handles has reached the cache-upper limit number (S105: YES), the cache controller 162 compares the path handle priorities calculated in S104 with the lowest value (lowest priority) of the path handle priorities of the cached path handles. Further, the cache controller 162 determines whether the path handle priorities calculated in S104 are equal to or greater than the lowest priority (S106).

When the path handle priorities calculated in S104 are smaller than the lowest priority (S106: NO), the process of S109 is performed.

In contrast, when the path handle priorities calculated in S104 are equal to or greater than the lowest priority (S106: YES), the cache controller 162 deletes a path handle with the lowest priority from the cache (S107).

In S108, the cache controller 162 caches the path handles generated in S103.

In S109, the imaging controller 161 designates the path handles generated in S103 to call the character imaging API, and controls the graphic library 164 to generate raster data corresponding to the combination of the input character and the input font family.

Then, the imaging controller 161 outputs the raster generated in S109 to the image forming unit 15, so that the image forming unit 15 forms an image of a character represented by the received raster data (S110).

The embodiment of the invention is for illustrative purposes only, and the scope of the invention is not limited thereto. Various modifications can be made without departing from the scope of the invention.

According to the embodiment, the cache-upper limit number is set in advance, and a path handle with higher path handle priority is cached within the range of the cache-upper limit number. However, the invention is not limited thereto. For example, after a threshold value of the path handle priority, which serves as a reference used for determining whether to perform a cache operation, is set in advance, if a path handle priority of a generated path handle is equal to or greater than the threshold value, the generated path handle may be cached.

What is claimed is:

1. An image forming apparatus comprising:
an input receiving unit that receives a character to be printed and a font family of the character as inputs;
a first outline specifying data generating unit that generates first outline specifying data corresponding to a combination of the character and the font family which are input to the input receiving unit;
an image formation data generating unit that generates data for image formation, which corresponds to the combination of the character and the font family, based on the generated first outline specifying data;
a cache unit that temporarily stores the first outline specifying data;
a priority calculating unit that calculates priorities related to the first outline specifying data based on the number of curve commands included in the first outline specifying data; and
a cache controller that determines whether to cache the generated first outline specifying data based on the calculated priorities, and stores the generated first outline specifying data in the cache unit when a positive determination result is obtained.

2. The image forming apparatus according to claim 1, further comprising a second outline specifying data generating unit that generates second outline specifying data corresponding to the combination of the character and the font family which are input to the input receiving unit,
wherein the first outline specifying data generating unit generates the first outline specifying data, which corresponds to the combination of the character and the font family, based on the generated second outline specifying data,
the priority calculating unit calculates the priorities based on the number of the curve commands included in the first outline specifying data, or the number of curve commands included in the second outline specifying data instead of the first outline specifying data,
the first outline specifying data generating unit and the image formation data generating unit have an input/output interface based on OpenVG specifications, and
the first outline specifying data has a data format based on the OpenVG specifications.

3. The image forming apparatus according to claim 1, wherein the priority calculating unit calculates the priorities based on the number of straight line commands in addition to the number of the curve commands.

4. The image forming apparatus according to claim 3, wherein the priority calculating unit calculates weighted priorities according to complexity of a curve represented by the curve commands when two or more types of curve commands exist.

5. The image forming apparatus according to claim 3, wherein the priority calculating unit replaces the curve commands with the straight line commands, which represent a plurality of straight lines expressing a curve represented by the curve commands, and calculates the priorities based on the number of straight line commands instead of the curve commands.

6. The image forming apparatus according to claim 1, wherein an upper limit number of the first outline specifying data, which is cacheable, is set in advance,
the cache unit stores the first outline specifying data and the priorities related to the first outline specifying data in such a manner that the first outline specifying data is linked to the corresponding priorities, and
the cache controller, in a case in which the number of the cached first outline specifying data reaches a cache-upper limit number, determines to cache the generated first outline specifying data when the priorities calculated by the priority calculating unit are equal to or greater than a lowest value of priorities related to the cached first outline specifying data.

7. The image forming apparatus according to claim 1, wherein the cache controller stores a threshold value of the priorities, which serves as a cache determination reference, and determines to cache the generated first outline specifying data when the priorities calculated by the priority calculating unit are equal to or greater than the threshold value.

8. An image forming method comprising:
receiving a character to be printed and a font family of the character as inputs;
generating first outline specifying data corresponding to a combination of the character and the font family which are input to the input receiving unit;
generating data for image formation, which corresponds to the combination of the character and the font family, based on the generated first outline specifying data;
calculating priorities related to the first outline specifying data based on the number of curve commands included in the first outline specifying data; and
determining whether to cache the generated first outline specifying data based on the calculated priorities, and caching the generated first outline specifying data when a positive determination result is obtained.

9. A computer program realizing an image forming method, the image forming method comprising:
receiving a character to be printed and a font family of the character as inputs;
generating first outline specifying data corresponding to a combination of the character and the font family which are input to the input receiving unit;
generating data for image formation, which corresponds to the combination of the character and the font family, based on the generated first outline specifying data;
calculating priorities related to the first outline specifying data based on the number of curve commands included in the first outline specifying data; and
determining whether to cache the generated first outline specifying data based on the calculated priorities, and caching the generated first outline specifying data when a positive determination result is obtained.
